(19) United States
(12) Patent Application Publication
(10) Pub. No.: US 2016/0292996 A1
(43) Pub. Date: Oct. 6, 2016

(54) PEDESTRIAN DETECTION RADAR USING ULTRA-WIDE BAND PULSE AND TRAFFIC LIGHT CONTROL SYSTEM INCLUDING THE SAME

(71) Applicant: Hoseotelnet Co., Ltd., Seoul (KR)

(72) Inventors: Sang Soo KIM, Paju-si (KR); Dong Il LEE, Seoul (KR)

(21) Appl. No.: 14/992,324

(22) Filed: Jan. 11, 2016

(30) Foreign Application Priority Data
Mar. 30, 2015 (KR) 10-2015-0044521
Sep. 17, 2015 (KR) 10-2015-0131897

(51) Int. Cl. G08G 1/005; G08G 1/07

(52) U.S. Cl. CPC G08G 1/005; G08G 1/07

(57) ABSTRACT

A pedestrian detection radar for detecting a human being using a crosswalk using an ultra-wide band (UWB) pulse signal and a traffic light control system including the same are provided. The pedestrian detection radar includes a first transmitting module configured to transmit a first signal having a UWB pulse to a detection region; a receiving module configured to receive a second signal which is reflected from an object in the detection region and is related with the first signal; an analyzing module configured to analyze the second. signal, to determine whether the object is a human being according to an analysis result, and to generate a determination signal; and a second transmitting module configured to generate a control signal using the determination signal and to transmit the control signal to the traffic light.

### CROSS-REFERENCE TO RELATED APPLICATION

This application claims priority under 35 U.S.C. §119 to Korean Patent Application Nos. 10-2015-0044521, filed Mar. 30, 2015, and 10-2015-0131897, filed Sep. 17, 2015, in the Korean Intellectual Property Office (KIPO), the entire contents of which are incorporated herein by reference.

### BACKGROUND

Embodiments of the inventive concept relate to a traffic light control system, and more particularly, to a pedestrian detection radar for detecting a pedestrian using a crosswalk using an ultra-wide band (UWB) pulse and a traffic light control system including the same.

Control schemes for traffic lights do not usually consider the number of pedestrians. These control schemes do not change even at night or when there are just a small number of pedestrians.

Crosswalk traffic lights turn green even when there is no pedestrian at a crosswalk. At this time, vehicles need to wait for the crosswalk traffic lights to change even though there are no people at the crosswalk. Such methods may cause inconvenience in driving vehicles around crosswalks. A UWB pulse (or a UWB pulse signal) uses a frequency ranging 3.1 to 5.1 GHz or 5.7 to 10.6 GHz. A radar using a UWB pulse signal has a very wide bandwidth and a narrow pulse width and thus has an excellent signal resolution.

### SUMMARY

Some embodiments of the inventive concept provide a pedestrian detection radar for transmitting an ultra-wide band (UWB) pulse signal to a detection region, receiving a signal reflected from an object, detecting whether the object is a human being or not, determining whether the object is about to enter a crosswalk when the object is a human being, and controlling traffic lights according to the determination result and a traffic light control system including the same.

According to some embodiments of the inventive concept, there is provided a pedestrian detection radar for controlling a traffic light using a control signal. The pedestrian detection radar includes a first transmitting module configured to transmit a first signal having a UWB pulse to a detection region; a receiving module configured to receive a second signal which is reflected from an object in the detection region and is related with the first signal; an analyzing module configured to analyze the second signal, to determine whether the object is a human being according to an analysis result, and to generate a determination signal; and a second transmitting module configured to generate the control signal using the determination signal and to transmit the control signal to the traffic light.

The analyzing module may analyze the second signal with reference to a biometric reference signal stored in a memory. The analyzing module may compare a level of the second signal with a level of the biometric reference signal and may generate the determination signal according to a comparison result, Alternatively, the analyzing module may compare a pattern of the second signal with a pattern of the biometric reference signal and may generate the determination signal according to a comparison result.

When the traffic light is a pedestrian signal light which is red and it is determined that the object is a human being who is about to enter a crosswalk, the analyzing module may generate the control signal for changing the pedestrian signal light from red to green. The analyzing module may determine that the object is a human being who is about to enter the crosswalk based on a result of comparing a level of the first signal with a level of the second signal. The analyzing module may calculate a distance between the pedestrian detection radar and the object using a difference between a time when the first signal is transmitted and a time when the second signal is received and may determine that the human being is about to enter the crosswalk according to a calculation result.

According to other embodiments of the inventive concept, there is provided a traffic light control system including a traffic light and a plurality of pedestrian detection radars configured to control the traffic light using a control signal. Each of the pedestrian detection radars includes a first transmitting module configured to transmit a first signal having a UWB pulse to a detection region; a receiving module configured to receive a second signal which is reflected from an object in the detection region and is related with the first signal; an analyzing module configured to analyze the second signal, to determine whether the object is a human being according to an analysis result, and to generate a determination signal; and a second transmitting module configured to generate the control signal using the determination signal and to transmit the control signal to the traffic light.

The analyzing module may analyze the second signal with reference to a biomettic reference signal stored in a memory. When the traffic light is a pedestrian signal light which is red and it is determined that the object is a human being who is about to enter a crosswalk, the analyzing module may generate the control signal for changing the pedestrian signal light from red to green.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a diagram of a traffic light control system according to some embodiments of the inventive concept;

FIG. 2A is a diagram of waveforms showing the level and pattern of second signals reflected from an object;

FIG. 2B is a diagram of waveforms of a second signal reflected from an object and received at different times;

FIG. 3 is a block diagram of a pedestrian detection radar according to some embodiments of the inventive concept;

FIG. 4 is a diagram of a traffic light control system according to other embodiments of the inventive concept; and

FIG. 5 is a flowchart of the operation of a traffic light control system according to some embodiments of the inventive concept.

### DETAILED DESCRIPTION OF THE EMBODIMENTS

The inventive concept now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not he limited by these terms. These terms are only used to distinguish one element from another, For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Hereinafter, the term “module” may indicate hardware for performing a function and operation corresponding to its name, a computer program code for performing a particular function and operation, or an electronic recording medium, e.g., a processor, equipped with a computer program code for performing a particular function and operation. In other words, the module is the functional and/or structural combination between hardware for realizing the inventive concept and/or software for driving the hardware.

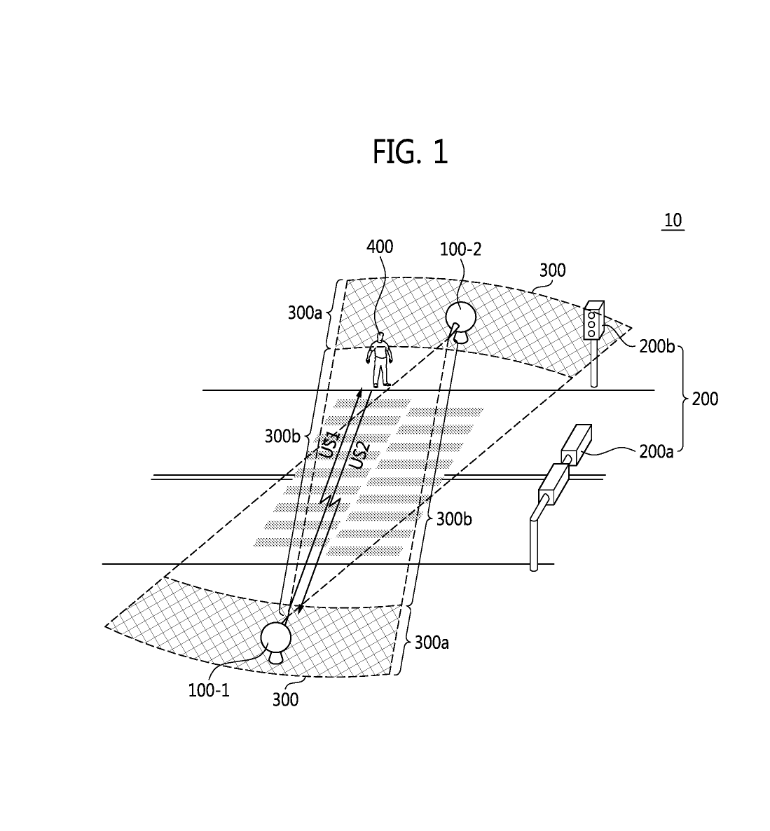

FIG. 1 is a diagram of a traffic light control system 10 according to some embodiments of the inventive concept. The traffic light control system 10 may include pedestrian detection radars 100-1 and 100-2 and a traffic light 200. The pedestrian detection radars 100-1 and 100-2 may be installed at both sidewalks, respectively, between which a crosswalk is laid. The traffic light 200 may include a signal light-for-vehicles (referred to as a “vehicle signal light”) 200a and/or a signal light-for-pedestrians (referred to as a “pedestrian signal light”) 200b.

The pedestrian detection radars 100-1 and 100-2 may transmit a first signal US1 having a ultra-wide band (UMB) pulse or a UMB pulse signal to a detection region 300. The detection region 300 may a region in which the pedestrian detection radars 100-1 and 100-2 can detect an object (such as a human being, a vehicle, or a thing).

Each of the pedestrian detection radars 100-1 and 100-2 may be installed at an appropriate position taking surrounding topography and radar performance into account. For instance, the pedestrian detection radars 100-1 and 100-2 may be installed at positions allowing the detection region 300 to cover the crosswalk and the sidewalks at both sides of the crosswalk when the pedestrian detection radars 100-1 and 100-2 transmit the first signal US1. Although it is illustrated in FIG. 1 that the pedestrian detection radar 100-1 transmits the first signal US1 and receives a second signal US2, the pedestrian detection radar 100-2 may also transmit the first signal US1 and receive the second signal US2.

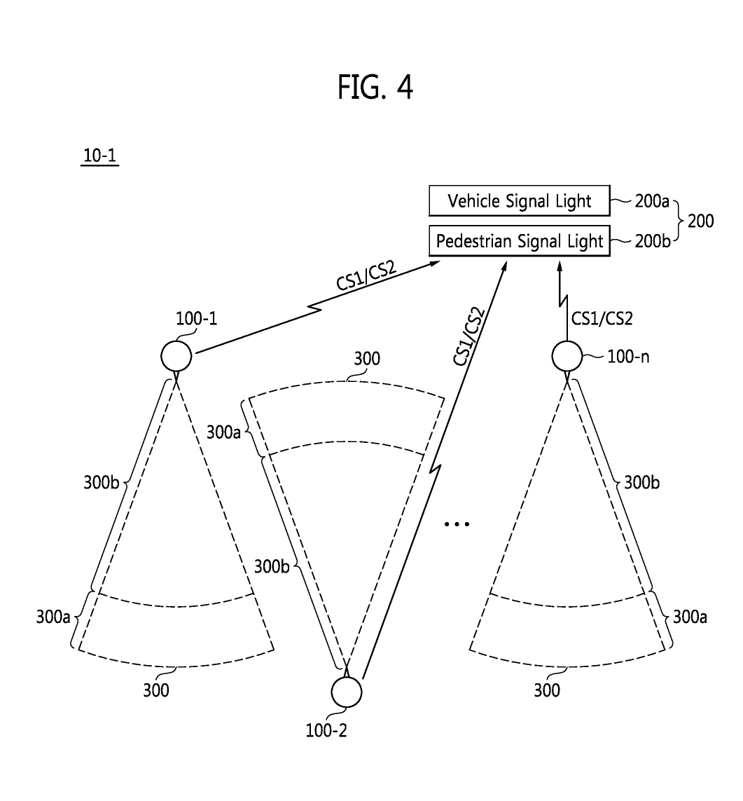

Two pedestrian detection radars 100-1 and 100-2 are installed in the embodiments illustrated in FIG. 1. However, if the coverage of the first signal US1 received by one pedestrian detection radar 100-1 includes all the crosswalk and the sidewalks at both sides of the crosswalk included in the detection region 300, one pedestrian detection radar 100-1 will be enough. In other words, the number of pedestrian detection radars included in the traffic light control system 10 may be changed in different embodiments. FIG. 4 shows a traffic light control system 10-1 including a plurality pedestrian detection radars 100-1 and 100-n.

When the first signal US1 transmitted from the pedestrian detection radars 100-1 and 100-2 encounters an object 400 existing in the detection region 300, the second signal US2 reflected from the object 400 is generated. The pedestrian detection radars 100-1 and 100-2 may receive the second signal US2 related with the first signal US1 that they have transmitted. The pedestrian detection radars 100-1 and 100-2 may analyze the second signal US2 and control the traffic light 200 according to the analysis result.

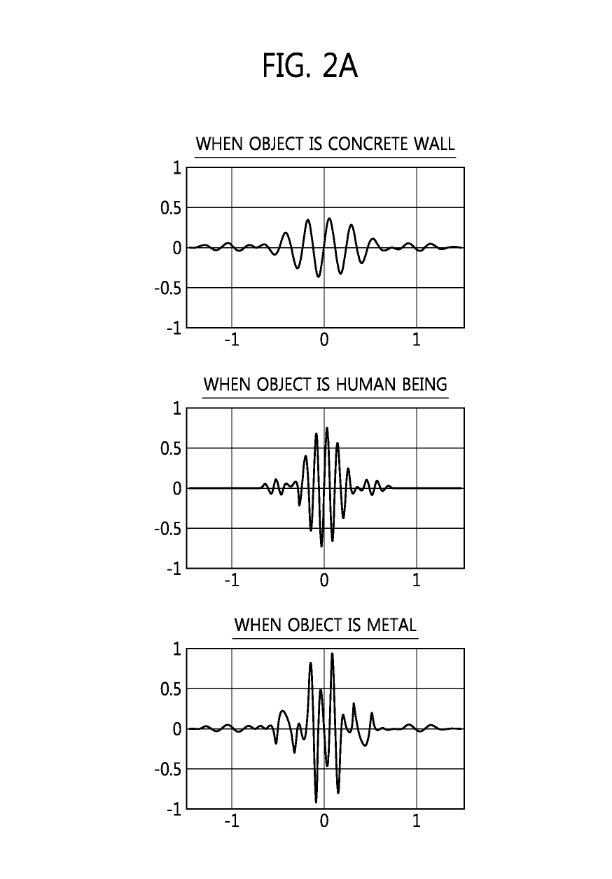

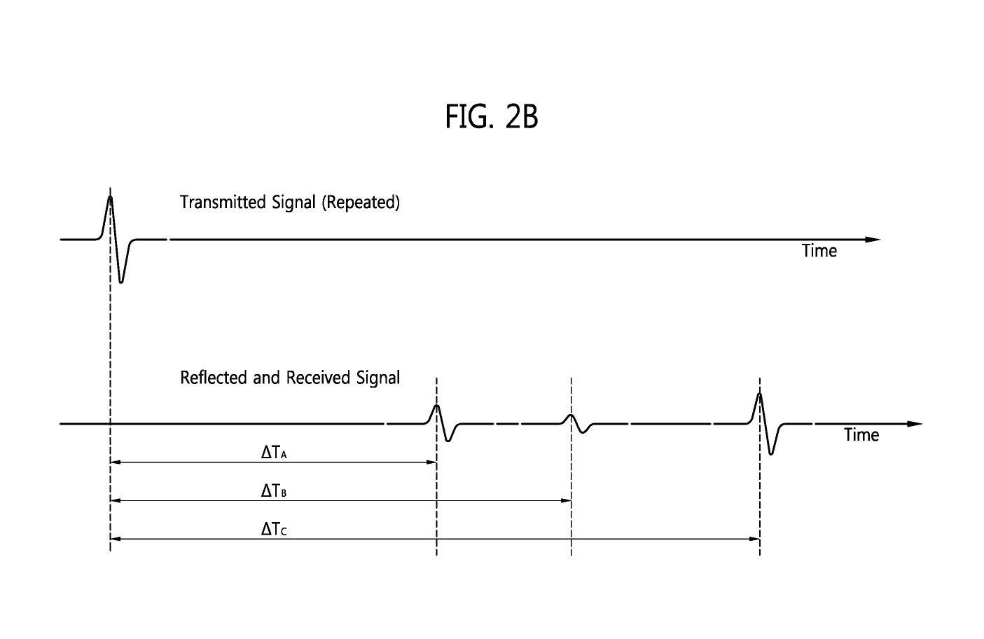

FIG. 2A is a diagram of waveforms showing the level and pattern of second signals reflected from an object. A waveform at the top of FIG. 2A shows the level and pattern of the second signal US2 when the object 400 is a concrete wall, a waveform in the middle of FIG. 2A shows the level and pattern of the second signal US2 when the object 400 is a human being, and a waveform at the bottom of FIG. 2A shows the level and pattern of the second signal US2 when the object 400 is a metal.

Referring to the waveforms shown in FIG. 2A, the level and pattern of the second signal US2 change according to what the object 400 is. FIG. 2B is a diagram of waveforms of the second signal US2 which is reflected from the object 400 and received at different times. FIG. 2B shows the three waveforms of the second signal US2 received by the pedestrian detection radar 100-1 at different times.

Referring to FIG. 2B, the pedestrian detection radar 100-1 may receive the second signal US2 at different times according to the distance between the object 400 and the pedestrian detection radar 100-1. As the distance between the object 400 and the pedestrian detection radar 100-1 increases, a time for the pedestrian detection radar 100-1 to receive the second signal US2 also increases.

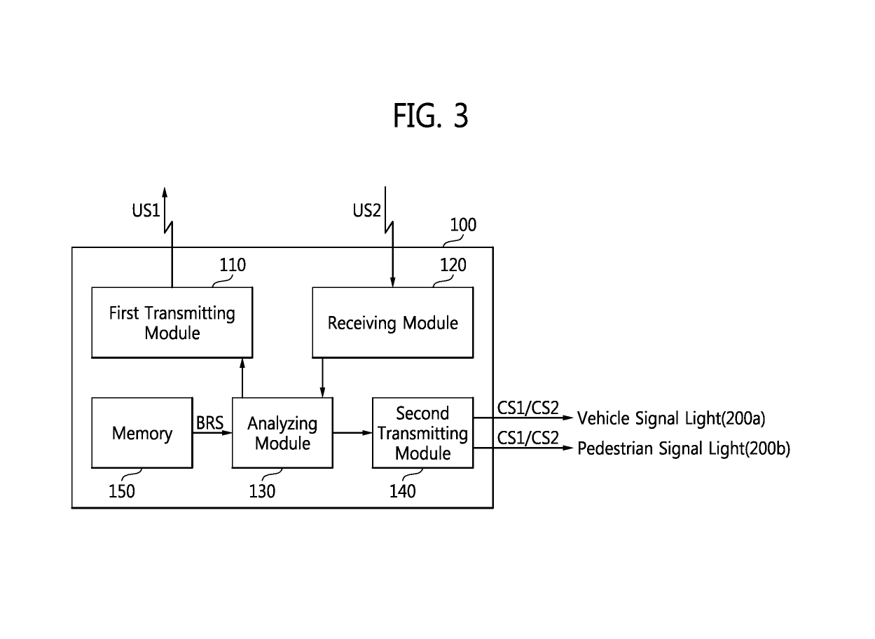

FIG. 3 is a block diagram of the pedestrian detection radar 100-1 or 100-2 according to some embodiments of the inventive concept. Referring to FIGS. 1 and 3, the pedestrian detection radar 100-1 or 100-2 (collective denoted by reference numeral 100) may include a first transmitting module 110, a receiving module 120, an analyzing module 130, a second transmitting module 140, and a memory 150.

Referring to FIGS. 1 through 3, the first transmitting module 110 may transmit the first signal US1 having a UWB pulse to the detection region 300. When the first signal US1 encounters the object 400 in the detection region 300, the second signal US2 reflected from the object 400 is generated. The receiving module 120 may receive the second signal US2 related with the first signal US1, i.e., the second signal US2 reflected from the object 400. The receiving module 120 may transmit the second signal US2 to the analyzing module 130.

The analyzing module 130 may analyze the second signal US2 and generate a detection signal according to the analysis result, The analyzing module 130 may analyze the second signal US2 based on the waveforms illustrated in FIG. 2A. For instance, the analyzing module 130 may compare the second signal US2 with a biometric reference signal BRS stored in the memory 150. The biometric reference signal BRS is a reference signal based on which whether the second signal US2 reflected from the object 400 indicates a human being is determined.

When the level and pattern of the second signal US2 are the same as or similar those of the biometric reference signal BRS, the analyzing module 130 may detect that the object 400 is a human being based on the analysis result. However, when the level and pattern of the second signal US2 are different from those of the biometric reference signal BRS, the analyzing module 130 may detect that the object 400 is not a human being based on the analysis result.

When the object 400 is detected as a human being, the analyzing module 130 may analyze the second signal US2 to determine whether the object 400, i.e., the human being is within a predetermined distance 300b and/or whether the object 400, i.e., the human being is moving toward the crosswalk. The analyzing module 130 may determine a kind of the object 400 (i.e., whether the object is a human being or not), the distance between the object 400 and the pedestrian detection radar 100, the travelling of the object, and/or the travelling direction of the object 400.

The analyzing module 130 may calculate the distance between the object 400 and the pedestrian detection radar 100 using a reception time of the second signal US2. The predetermined distance 300b is a distance from the pedestrian detection radar 100 and may be set in centimeter or meter unit. For instance, when the distance from the pedestrian detection radar 100 to the opposite end of the crosswalk is 30 m, the predetermined distance 300b may be set to 33 m from the pedestrian detection radar 100. The number is just an example and the predetermined distance 300b is not restricted thereto.

The analyzing module 130 may determine whether the object 400 is within the predetermined distance 300b and may generate a determination signal for controlling the traffic light 200 according to the determination result. For instance, when the predetermined distance 300b is 33 m from the pedestrian detection radar 100 and the object 400 is within the predetermined distance 300b, the object 400 may be located around the crosswalk. When the object 400 is within the predetermined distance 300b, the analyzing module 130 may generate a determination signal indicating that the object 400 is a human being who is on the crosswalk or is about to enter the crosswalk.

When the object 400 is in an outer region 300a beyond the predetermined distance 300b, the analyzing module 130 may determine that the object 400 is not a human being who is about to enter the crosswalk. When the object 400 is in the outer region 300a, the analyzing module 130 may not generate a determination signal.

The analyzing module 130 may compare the level of the first signal US1 with the level of the second signal US2 and may determine whether the object 400 is moving toward the crosswalk based on the comparison result. When a thing reflects light, a level change may occur between an incident wave and a reflected wave according to the Doppler effect. When the level of the first signal US1 and the level of the second signal US2 are different from each other, the analyzing module 130 may determine the object 400 is moving toward the crosswalk and generate a determination signal for controlling the traffic light 200 according to the determination result.

When the object 400 is in the outer region 300a beyond the predetermined distance 300b and the levels of the first and second signals US1 and US2 are different from each other, the analyzing module 130 may also determine the object 400 is moving toward the crosswalk and generate the determination signal for controlling the traffic light 200 according to the determination result. The second transmitting module 140 transmits a control signal CS1 and/or CS2 for controlling the traffic light 200 to the traffic light 200 based on the determination signal generated by the analyzing module 130.

When it is determined that the object 400 is a human being who is standing on the crosswalk or is about to enter the crosswalk, the analyzing module 130 may generate a determination signal having a first state (e.g., a high level or logic 1). The second transmitting module 140 may transmit the first control signal CS1 to the traffic light 200 based on the determination signal having the first state.

When it is determined that the object 400 is not a human being or the object 400 is not moving toward the crosswalk in the outer region 300a, the analyzing module 130 may generate a determination signal having a second state (e.g., a low level or logic 0). The second transmitting module 140 may transmit the second control signal CS2 to the traffic 200 based on the determination signal having the second state.

When the traffic light 200 is the pedestrian signal light 200b and the pedestrian signal light 200b is red and receives the first control signal CS1, the pedestrian signal light 200b may change from red to green. When the pedestrian signal light 200b is green and receives the first control signal CS1, the pedestrian signal light 200b may remain green. When the traffic light 200 is the pedestrian signal light 200b and the pedestrian signal light 200b is red and receives the second control signal CS2, the pedestrian signal light 200b may remain red. When the pedestrian signal light 200b is green and receives the second control signal CS2, the pedestrian signal light 200b may change from green to red.

When the traffic light 200 is the vehicle signal light 200a and the vehicle signal light 200a is red and receives the first control signal CS1, the vehicle signal light 200a may remain red. When vehicle signal light 200a is green and receives the first control signal CS1, the vehicle signal light 200a may change from green to red. When the traffic light 200 is the vehicle signal light 200a and the vehicle signal light 200a is red and receives the second control signal CS2, the vehicle signal light 200a may change to green. When the vehicle signal light 200a is green and receives the second control signal CS2, the vehicle signal light 200a may remain green.

FIG. 4 is a traffic light control system 10-1 according to other embodiments of the inventive concept. Referring to FIGS. 1 through 4, the traffic light control system 10-1 may include a plurality of the pedestrian detection radars 100-1 through 100-n installed at sidewalks at both sides of a crosswalk. Apart from the plurality of the pedestrian detection radars 100-1 through 100-n, the structure and operations of the traffic light control system 10-1 illustrated in FIG. 4 are the same as or similar to those of the traffic light control system 10 described above with reference to FIGS. 1 through 3. Thus, the detailed descriptions of the structure and operations of the traffic light control system 10-1 will be omitted,

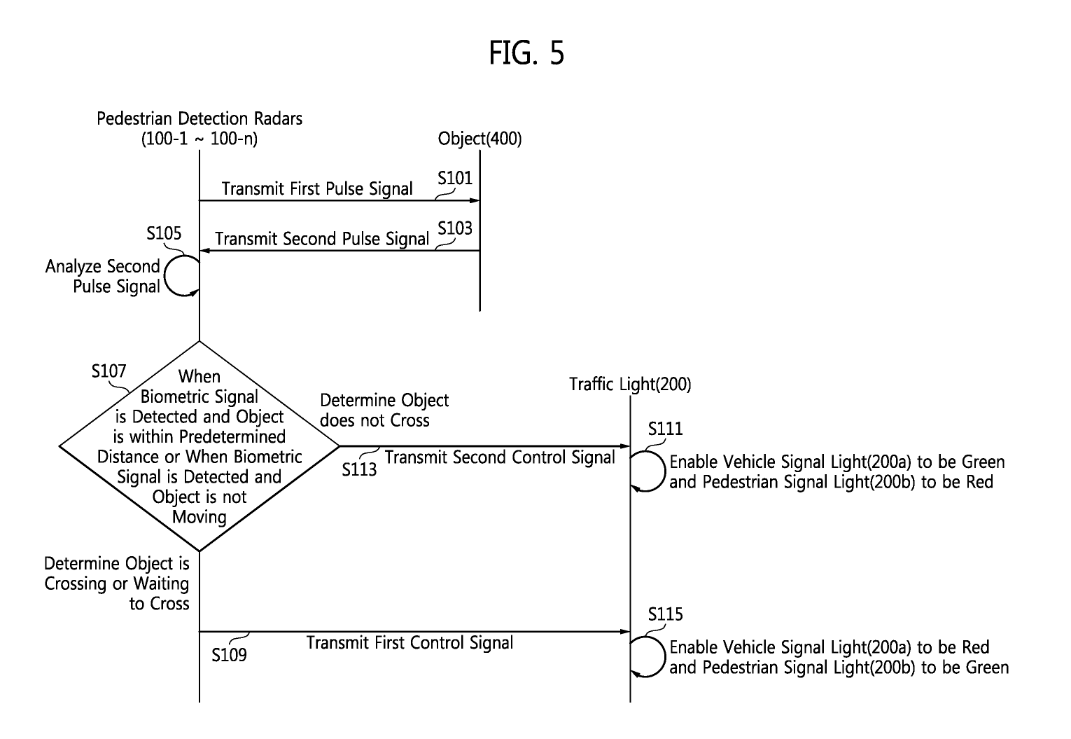

FIG. 5 is a flowchart of the operation of the traffic light control system 10 or 10-1 according to some embodiments of the inventive concept. Referring to FIGS. 1 through 5, the traffic light control system 10 or 10-1 may include a plurality of the pedestrian detection radars 100-1 through 100-n (where “n” is a natural number of at least 2), the vehicle signal light 200a, and the pedestrian signal light 200b.

Each of the pedestrian detection radars 100-1 through 100-n may transmit the first signal US1 having a UWB pulse, e.g., a first pulse signal to the detection region 300 in operation S101. When the first signal US1 transmitted from each of the pedestrian detection radars 100-1 through 100-n is reflected from the object 400 in the detection region 300, the second signal US2 reflected from the object 400, e.g., a second pulse signal is generated. Each of the pedestrian detection radars 100-1 through 100-n may receive the second signal US2 from the object 400 in operation S103. Each of the pedestrian detection radars 100-1 through 100-n may analyze the second signal US2 in operation 5105 and may generate the control signals CS1 and CS2 for controlling the traffic light 200 including the vehicle signal light 200a and the pedestrian signal light 200b according to the analysis result.

Each of the pedestrian detection radars 100-1 through 100-n may compare the second signal US2 with the biometric reference signal BRS in operation S107. When the level and pattern of the second signal US2 are the same as or similar to those of the biometric reference signal BRS, each of the pedestrian detection radars 100-1 through 100-n may detect that the object 400 is a human being.

When the object 400 is detected as a human being, each of the pedestrian detection radars 100-1 through 100-n may analyze the second signal US2 to determine whether the object 400 is within the predetermined distance 300b and/or whether the object 400 is moving toward the crosswalk in operation S107.

When it is determined that the object 400 is a human being who is on the crosswalk or who is about to enter the crosswalk in operation S107, each of the pedestrian detection radars 100-1 through 100-n may transmit the first signal CS1 to the traffic light 200 in operation S109. When it is determined that the object 400 is not a human being or the object 400 is not moving toward the crosswalk in the outer region 300a beyond the predetermined distance 300b in operation S107, each of the pedestrian detection radars 100-1 through 100-n may transmit the second control signal CS2 to the traffic light 200 in operation S113.

When the traffic light 200 is the pedestrian signal light 200b and the pedestrian signal light 200b is red and receives the first control signal CS1, the pedestrian signal light 200b changes from red to green. When the pedestrian signal light 200b is green and receives the first control signal CS1, the pedestrian signal light 200b remains green in operation S115.

When the traffic light 200 is the pedestrian signal light 200b and the pedestrian signal light 200b is red and receives the second control signal CS2, the pedestrian signal light 200b remains red. When the pedestrian signal light 200b is green and receives the second control signal CS2, the pedestrian signal light 200b changes from green to red in operation S111.

When the traffic light 200 is the vehicle signal light 200a and the vehicle signal 200a is red and receives the first control signal CS1, the vehicle signal light 200a remains red. When the vehicle signal light 200a is green and receives the first control signal CS1. the vehicle signal light 200a changes from green to red in operation SI15.

When the traffic light 200 is the vehicle signal light 200a and the vehicle signal light 200a is red and receives the second control signal CS2, the vehicle signal light 200a changes from red to green. When the vehicle signal light 200a is green and receives the second control signal CS2, the vehicle signal light 200a remains green in operation S111.

As described above, according to some embodiments of the inventive concept, a traffic light control system detects whether an object is a human being or a thing and controls a traffic light according to the detection result, thereby decreasing errors in the traffic light. In addition, the traffic light control system determines whether the object is a human being who is about to use a crosswalk and controls the traffic light according to the determination result, thereby decreasing the errors in the traffic light.

While the inventive concept has been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. A pedestrian detection radar for controlling a traffic light using a control signal, the pedestrian detection radar comprising:
a first transmitting module configured to transmit a first signal having an ultra-wide band (UWB) pulse to a detection region;
a receiving module configured to receive a second signal which is reflected from an object n the detection region and is related with the first signal;
an analyzing module configured to analyze the second signal, to determine whether the object is a human being according to an analysis result, and to generate a determination signal; and
a second transmitting module configured to generate the control signal using the determination signal and to transmit the control signal to the traffic light.

2. The pedestrian detection radar of claim I, wherein the analyzing module analyzes the second signal with reference to a biometric reference signal stored in a memory.

3. The pedestrian detection radar of claim 2, wherein the analyzing module compares a level of the second signal with a level of the biometric reference signal and generates the determination signal according to a comparison result.

4. The pedestrian detection radar of claim 2, wherein the analyzing module compares a pattern of the second signal with a pattern of the biometric reference signal and generates the determination signal according to a comparison result.

5. The pedestrian detection radar of claim I. wherein when the traffic light is a pedestrian signal light which is red and it is determined that the object is a human being who is about to enter a crosswalk, the analyzing module generates the control signal for changing the pedestrian signal light from red to green.

6. The pedestrian detection radar of claim 5, wherein the analyzing module determines that the object is a human being who is about to enter the crosswalk based on a result of comparing a level of the first signal with a level of the second signal.

7. The pedestrian detection radar of claim 5, wherein the analyzing module calculates a distance between the pedestrian detection radar and the object using a difference between a time when the first signal is transmitted and a time when the second signal is received and determines that the human being is about to enter the crosswalk according to a calculation result.

8. A traffic light control system comprising:
a traffic light; and
a plurality of pedestrian detection radars configured to control the traffic light using a control signal, each of the pedestrian detection radars comprising a first transmitting module configured to transmit a first signal having an ultra-wide band (UWB) pulse to a detection region; a receiving module configured to receive a second signal which is reflected from an object in the detection region and is related with the first signal; an analyzing module configured to analyze the second signal, to determine whether the object is a human being according to an analysis result, and to generate a determination signal; and a second transmitting module configured to generate the control signal using the determination signal and to transmit the control signal to the traffic light.

9. The traffic light control system of claim 8, wherein the analyzing module analyzes the second signal with reference to a biometric reference signal stored in a memory.

10. The traffic light control system of claim 8, wherein when the traffic light is a pedestrian signal light which is red and it is determined that the object is a human being who is about to enter a crosswalk, the analyzing module generates the control signal for changing the pedestrian signal light from red to green.
